(19) United States
(12) Patent Application Publication
(10) Pub. No.: US 2026/0277485 A1
(43) Pub. Date: Sep. 17, 2026

(54) STORAGE DEVICE

(71) Applicant: Samsung Electronics Co., Ltd., Suwon-si, (KR)

(72) Inventors: Siamak ARYA, Cupertino, CA (US); James David SAWIN, Sterling, MA (US); Mark Allen GAERTNER, Fort Myers, FL (US)

(21) Appl. No.: 19/565,509

(22) Filed: Mar. 12, 2026

Related U.S. Application Data
(60) Provisional application No. 63/771,168, filed on Mar. 13, 2025.

(51) Int. Cl. G06F 3/06

(52) U.S. Cl. CPC G06F 3/0659; G06F 3/0619; G06F 3/0688

(57) ABSTRACT

A storage device. In some embodiments, a storage device includes: first and second storage elements; and a processing circuit, configured to perform a method, the method including: determining that a first bit of a storage element availability bit map is set, the first bit corresponding to the first storage element, the first bit of the storage element availability bit map indicating that the first storage element is available to perform a write operation; determining that a first bit of a first super select line bit map is set, the first bit of the first super select line bit map corresponding to a first select line and to the first storage element; determining that a first bit of a first masking bit map is set, the first bit of the first masking bit map corresponding to the first storage element; and performing a first write operation in the first storage element.

### CROSS-REFERENCE TO RELATED APPLICATION(S)

The present application claims priority to and the benefit of U.S. Provisional Application No. 63/771,168, filed Mar. 13, 2025, entitled “AVOIDING DIE CONTENTION WITH MULTIPLE STREAMS OF DATA”, the entire content of which is incorporated herein by reference.

### FIELD

One or more aspects of embodiments according to the present disclosure relate to storage devices, and more particularly to a system and method for die allocation.

### BACKGROUND

Storage devices (e.g., nonvolatile storage devices) may be includes in computing systems. In such a system, the nonvolatile storage device may be connected to a host, which may feed data to the nonvolatile storage device through a plurality of streams, to be written to a plurality of dies of the nonvolatile storage device.

It is with respect to this general technical environment that aspects of the present disclosure are related.

The above information disclosed in this Background section is only for enhancement of understanding of the background and therefore the information discussed in this Background section does not necessarily constitute prior art.

### SUMMARY

According to an embodiment of the present disclosure, there is provided a method, including: determining that a first bit of a storage element availability bit map is set, the first bit corresponding to a first storage element of a nonvolatile memory storage device, the first bit of the storage element availability bit map indicating that the first storage element is available to perform a write operation; determining that a first bit of a first super select line bit map is set, the first bit of the first super select line bit map corresponding to a first select line and to the first storage element; and in response to determining that the first bit of the storage element availability bit map is set and that the first bit of the first super select line bit map is set, performing a first write operation in the first storage element.

In some embodiments, the method further includes clearing the first bit of the first super select line bit map.

In some embodiments, the first write operation is a first-pass write operation using the first select line.

In some embodiments, the method further includes: determining that the first bit of the storage element availability bit map is set; determining that a first bit of a second super select line bit map is set, the first bit of the second super select line bit map corresponding to a second select line and to the first storage element; and in response to determining that the first bit of the storage element availability bit map is set and that the first bit of the second super select line bit map is set, performing a second write operation in the first storage element.

In some embodiments, the second write operation is a first-pass write operation using the second select line.

In some embodiments, the method further includes performing a third write operation in the first storage element, after performing the second write operation, wherein the third write operation is a second-pass write operation using the first select line.

In some embodiments, the method further includes: determining that a second bit of the storage element availability bit map is cleared, the second bit corresponding to a second storage element of the nonvolatile memory storage device, the second bit of the storage element availability bit map indicating that the second storage element is not available to perform a write operation; in response to determining that the second bit of the storage element availability bit map is cleared: determining that the first bit of the storage element availability bit map is set; determining that a first bit of a second super select line bit map is set, the first bit of the second super select line bit map corresponding to a third select line and to the first storage element; and in response to determining that the first bit of the storage element availability bit map is set and that the first bit of the first super select line bit map is set, performing a fourth write operation in the first storage element.

In some embodiments: the first super select line bit map is stored in a first bit map storage space the first super select line bit map includes a plurality of bits, and the method further includes: determining that the bits of the first super select line bit map are cleared, and in response to determining that the bits of the first super select line bit map are cleared, allocating the first bit map storage space to a third super select line bit map.

In some embodiments, the allocating is further in response to a state of a state tracker, the state tracker being configured to change states in response to: an assignment of a storage element for performance of the first write operation, or an allocation of a bit map storage space to a super select line bit map.

In some embodiments, the first write operation is a second-pass write operation performed on two-pass memory.

In some embodiments, the first write operation is a write operation performed on one-pass memory.

In some embodiments, the first storage element is a die.

In some embodiments, the first storage element is a plane of a die.

According to an embodiment of the present disclosure, there is provided a nonvolatile storage device, including: a first storage element; a second storage element; and a processing circuit, configured to perform a method, the method including: determining that a first bit of a storage element availability bit map is set, the first bit corresponding to the first storage element, the first bit of the storage element availability bit map indicating that the first storage element is available to perform a write operation; determining that a first bit of a first super select line bit map is set, the first bit of the first super select line bit map corresponding to a first select line and to the first storage element; and in response to determining that the first bit of the storage element availability bit map is set and that the first bit of the first super select line bit map is set, performing a first write operation in the first storage element.

In some embodiments, the method further includes: determining that the first bit of the storage element availability bit map is set; determining that a first bit of a second super select line bit map is set, the first bit of the second super select line bit map corresponding to a second select line and to the first storage element; and in response to determining that the first bit of the storage element availability bit map is set and that the first bit of the second super select line bit map is set, performing a second write operation in the first storage element.

In some embodiments, the second write operation is a first-pass write operation using the second select line.

In some embodiments, the method further includes performing a third write operation in the first storage element, after performing the second write operation, wherein the third write operation is a second-pass write operation using the first select line.

In some embodiments, the method further includes: determining that a second bit of the storage element availability bit map is cleared, the second bit corresponding to the second storage element, the second bit of the storage element availability bit map indicating that the second storage element is not available to perform a write operation; in response to determining that the second bit of the storage element availability bit map is cleared: determining that the first bit of the storage element availability bit map is set; determining that a first bit of a second super select line bit map is set, the first bit of the second super select line bit map corresponding to a third select line and to the first storage element; and in response to determining that the first bit of the storage element availability bit map is set and that the first bit of the first super select line bit map is set, performing a fourth write operation in the first storage element.

In some embodiments: the first super select line bit map is stored in a first bit map storage space, the first super select line bit map includes a plurality of bits, and the method further includes: determining that the bits of the first super select line bit map are cleared, and in response to determining that the bits of the first super select line bit map are cleared, allocating the first bit map storage space to a third super select line bit map.

According to an embodiment of the present disclosure, there is provided a nonvolatile storage device, including: a first storage element; a second storage element; and means for processing, configured to perform a method, the method including: determining that a first bit of a storage element availability bit map is set, the first bit corresponding to the first storage element, the first bit of the storage element availability bit map indicating that the first storage element is available to perform a write operation; determining that a first bit of a first super select line bit map is set, the first bit of the first super select line bit map corresponding to a first select line and to the first storage element; and in response to determining that the first bit of the storage element availability bit map is set and that the first bit of the first super select line bit map is set, performing a first write operation in the first storage element.

According to an embodiment of the present disclosure, there is provided a method, including: determining that a first bit of a storage element availability bit map is set, the first bit corresponding to a first storage element of a nonvolatile memory storage device, the first bit of the storage element availability bit map indicating that the first storage element is available to perform a write operation; determining that a first bit of a first super select line bit map is set, the first bit of the first super select line bit map corresponding to a first select line and to the first storage element; determining that a first bit of a first masking bit map is set, the first bit of the first masking bit map corresponding to the first storage element; and in response to determining that the first bit of the storage element availability bit map is set, and that the first bit of the first super select line bit map is set, and that the first bit of the first masking bit map is set, performing a first write operation in the first storage element.

In some embodiments, the method further includes clearing the first bit of the first masking bit map.

In some embodiments: a redundant array of storage elements includes the first storage element; and the first bit of the first masking bit map corresponds to the first storage element.

In some embodiments, the method further includes: determining that a second bit of the first masking bit map is set, and performing a write operation on a second storage element of the redundant array of storage elements, wherein the second bit of the first masking bit map corresponds to the second storage element.

In some embodiments, the method further includes: clearing the second bit of the first masking bit map; determining that a plurality of bits of the first masking bit map are cleared; and in response to determining that the plurality of bits of the first masking bit map are cleared, performing a write operation with parity data.

In some embodiments: the first bit of the first masking bit map corresponds to a first channel of a plurality of channels of the nonvolatile memory storage device.

In some embodiments, the method further includes clearing a second bit of the first masking bit map, wherein the second bit corresponds to the first channel of the nonvolatile memory storage device.

In some embodiments, the method further includes: determining that a plurality of bits of the first masking bit map are cleared; and in response to determining that the plurality of bits of the first masking bit map are cleared, setting the plurality of bits.

In some embodiments, the method further includes initializing the first super select line bit map from a master bit map.

In some embodiments, the master bit map includes a plurality of set bits, the set bits corresponding to a domain of the nonvolatile memory storage device.

According to an embodiment of the present disclosure, there is provided a nonvolatile storage device, including: a first storage element; a second storage element; and a processing circuit, configured to perform a method, the method including: determining that a first bit of a storage element availability bit map is set, the first bit corresponding to the first storage element, the first bit of the storage element availability bit map indicating that the first storage element is available to perform a write operation; determining that a first bit of a first super select line bit map is set, the first bit of the first super select line bit map corresponding to a first select line and to the first storage element; determining that a first bit of a first masking bit map is set, the first bit of the first masking bit map corresponding to the first storage element; and in response to determining that the first bit of the storage element availability bit map is set, and that the first bit of the first super select line bit map is set, and that the first bit of the first masking bit map is set, performing a first write operation in the first storage element.

In some embodiments, the method further includes clearing the first bit of the first masking bit map.

In some embodiments: a redundant array of storage elements includes the first storage element; and the first bit of the first masking bit map corresponds to the first storage element.

In some embodiments: the redundant array of storage elements includes the second storage element; and the method further includes: determining that a second bit of the first masking bit map is set, and performing a write operation on the second storage element, wherein the second bit of the first masking bit map corresponds to the second storage element.

In some embodiments, the method further includes: clearing the second bit of the first masking bit map; determining that a plurality of bits of the first masking bit map are cleared; and in response to determining that the plurality of bits of the first masking bit map are cleared, performing a write operation with parity data.

In some embodiments: the first bit of the first masking bit map corresponds to a first channel of a plurality of channels of the nonvolatile memory storage device.

In some embodiments, the method further includes clearing a second bit of the first masking bit map, wherein the second bit corresponds to the first channel of the nonvolatile memory storage device.

In some embodiments, the method further includes: determining that a plurality of bits of the first masking bit map are cleared; and in response to determining that the plurality of bits of the first masking bit map are cleared, setting the plurality of bits.

In some embodiments: the method further includes initializing the first super select line bit map from a master bit map, and the master bit map includes a plurality of set bits, the set bits corresponding to a domain of the nonvolatile memory storage device.

According to an embodiment of the present disclosure, there is provided a nonvolatile storage device, including: a first storage element; a second storage element; and means for processing, configured to perform a method, the method including: determining that a first bit of a storage element availability bit map is set, the first bit corresponding to the first storage element, the first bit of the storage element availability bit map indicating that the first storage element is available to perform a write operation; determining that a first bit of a first super select line bit map is set, the first bit of the first super select line bit map corresponding to a first select line and to the first storage element; determining that a first bit of a first masking bit map is set, the first bit of the first masking bit map corresponding to the first storage element; and in response to determining that the first bit of the storage element availability bit map is set, and that the first bit of the first super select line bit map is set, and that the first bit of the first masking bit map is set, performing a first write operation in the first storage element.

### BRIEF DESCRIPTION OF THE DRAWINGS

These and other features and advantages of the present disclosure will be appreciated and understood with reference to the specification, claims, and appended drawings wherein:

FIG. 1 is a block diagram of a computing system, according to an embodiment of the present disclosure;

FIG. 2 is a block diagram of a storage device connected to a host, according to an embodiment of the present disclosure;

FIG. 3A is a schematic drawing of connections to an array of memory cells, according to an embodiment of the present disclosure;

FIG. 3B is a schematic drawing of stacked select lines in a nonvolatile memory die, according to an embodiment of the present disclosure;

FIG. 3C is a schematic drawing of memory dies, according to an embodiment of the present disclosure;

FIG. 4A is a block diagram of a portion of a system for die selection, according to an embodiment of the present disclosure;

FIG. 4B is a block diagram of a portion of a system for die selection, according to an embodiment of the present disclosure;

FIG. 4C is a block diagram of a portion of a system for die selection, according to an embodiment of the present disclosure;

FIG. 4D is a block diagram of a portion of a system for die selection, according to an embodiment of the present disclosure;

FIG. 4E is a block diagram of a portion of a system for die selection, according to an embodiment of the present disclosure;

FIG. 4F is a block diagram of a portion of a system for die selection, according to an embodiment of the present disclosure;

FIG. 4G is a block diagram of a portion of a system for die selection, according to an embodiment of the present disclosure;

FIG. 5A is a flow chart of a method for performing a priority ranking, according to an embodiment of the present disclosure;

FIG. 5B is a block diagram of a priority ranking, according to an embodiment of the present disclosure;

FIG. 6A is a diagram of a set of states of a system for die selection, according to an embodiment of the present disclosure;

FIG. 6B is a diagram of a set of states of a system for die selection, according to an embodiment of the present disclosure;

FIG. 6C is a diagram of a set of states of a system for die selection, according to an embodiment of the present disclosure;

FIG. 6D is a diagram of a set of states of a system for die selection, according to an embodiment of the present disclosure;

FIG. 7A is a flow chart, according to an embodiment of the present disclosure;

FIG. 7B is a flow chart, according to an embodiment of the present disclosure;

FIG. 8A is a flow chart, according to an embodiment of the present disclosure;
and

FIG. 8B is a flow chart, according to an embodiment of the present disclosure.

### DETAILED DESCRIPTION

The detailed description set forth below in connection with the appended drawings is intended as a description of exemplary embodiments of a storage device provided in accordance with the present disclosure and is not intended to represent the only forms in which the present disclosure may be constructed or utilized. The description sets forth the features of the present disclosure in connection with the illustrated embodiments. It is to be understood, however, that the same or equivalent functions and structures may be accomplished by different embodiments that are also intended to be encompassed within the scope of the disclosure. As denoted elsewhere herein, like element numbers are intended to indicate like elements or features.

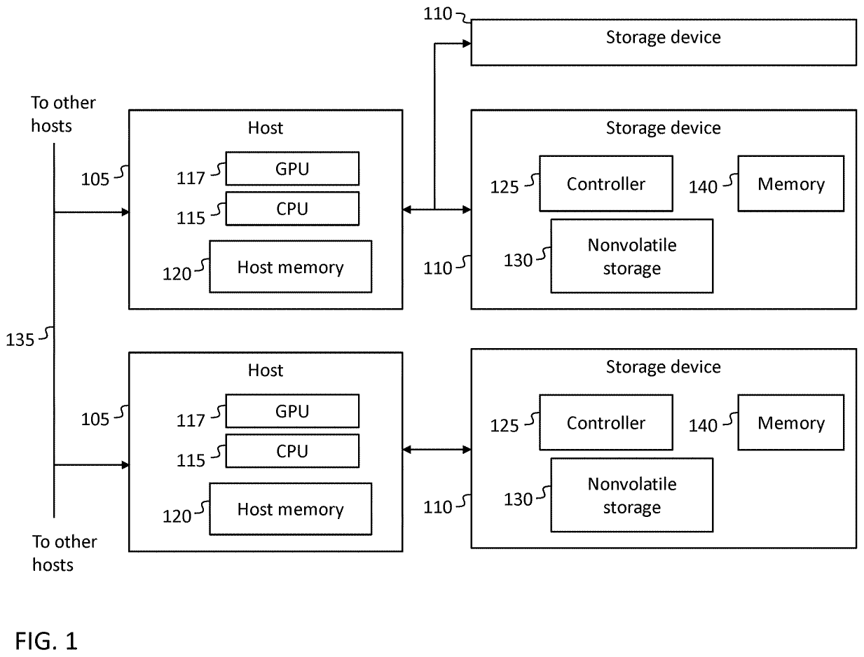

FIG. 1 is a block diagram of a computing system, in some embodiments. The computing system includes a host (or a plurality of hosts) 105 and a storage device (or “nonvolatile memory storage device”) (or a plurality of storage devices) 110. The storage device 110 may be connected to the host 105 as illustrated, or, equivalently, the storage device 110 may be considered to be part of the host 105 (for example, the storage device 110 may share an enclosure with other components of the host 105). Each host 105 may include, as shown in FIG. 1, a central processing unit (or “host CPU”) 115, a graphics processing unit (GPU) 117 and a host memory 120. In some embodiments, the host 105 includes one or more CPUs, one or more GPUs, one or more software (SW) applications that may be distributed across multiple diverse compute and network resources, or any combination of such elements. Each storage device 110 may include a storage device controller 125 (which may be or include a processing circuit) and nonvolatile storage 130. The storage device may also include volatile memory 140 (e.g., static random-access memory), e.g., in the storage device controller 125, or in a separate package.

A host may be connected to a plurality of storage devices 110, as shown for one of the hosts 105 in FIG. 1. Each storage device may receive commands from the host 105 and perform data storage and retrieval operations in response to the commands. Each storage device 110 (e.g., a storage device 110 that is a Peripheral Component Interconnect Express (PCIe) Nonvolatile Memory Express (NVMe) drive) may be capable of directly accessing the host memory 120, in a process which may be referred to as direct memory access (DMA). Because of this, the throughput of data transfer operations between the storage devices may be higher than it would be if the host CPU 115 were involved in the reading and writing operations involved in such data transfer operations, and the latency of data transfer operations between the storage devices may be lower than it would be if the host CPU 115 were involved in the reading and writing operations involved in such data transfer operations. In some embodiments, one or more of the storage devices 110 may be NVMe over Fabrics (NVMe-oF) storage devices 110 and may not have DMA access to the host 105. In such an embodiment, the interface may support “request data” and “push data from host to device” functions, which the storage device 110 may use to exchange data efficiently with the host 105.

As mentioned above, the computing system may include, as illustrated in FIG. 1, a plurality of hosts 105. Each host 105 is connected to a network 135 (e.g., an ethernet network), which may allow the hosts 105 to communicate with each other. The operating systems of the hosts 105 may make it possible for any host 105 to access the storage device 110 or storage devices 110 of any other host 105. For ease of illustration, FIG. 1 shows only two hosts; in some embodiments more than two hosts are connected to the network 135, as indicated by the notations “to other hosts” in FIG. 1, which shows that additional hosts may be connected to the network 135.

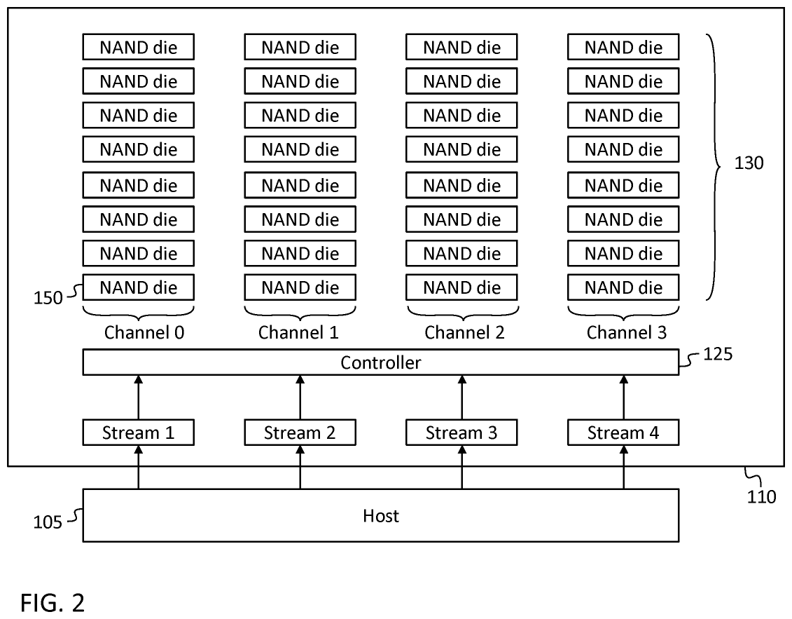

FIG. 2 shows aspects of the internal organization of a storage device 110, in some embodiments. The nonvolatile storage 130 may include (e.g., consist of) a plurality of NAND-flash dies 150 organized into groups, each group connected by a channel to the storage device controller 125. Each channel may be an independent data path, capable of a certain throughput, from the controller to the set of dies of the channel (e.g., connected to the channel); as such, the total data throughput possible between the storage device controller 125 and the nonvolatile storage 130 may be proportional to the number of channels, if all of the channels are in use simultaneously. FIG. 2 shows 4 channels for ease of illustration; in some embodiments a storage device 110 may have more or fewer channels (e.g., a storage device 110 may have 16 channels). FIG. 2 shows 8 dies in each channel for ease of illustration; in some embodiments a storage device 110 may have more or fewer dies per channel (e.g., a storage device 110 may have 16 dies per channel).

Data may be exchanged between the host 105 and the storage device 110 through a plurality of streams, each of which may be a separate virtual connection between the host 105 and the storage device 110. FIG. 2 shows 4 streams for ease of illustration; in some embodiments more or fewer streams may be used between a storage device 110 and a host 105, and the number of streams need not be the same as the number of channels (e.g., the number of streams may be greater or less than the number of channels).

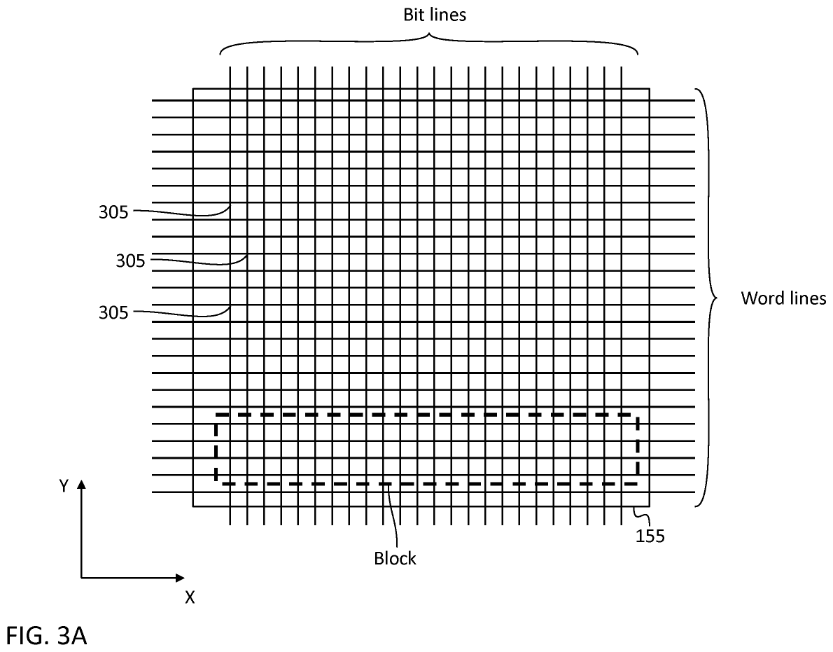

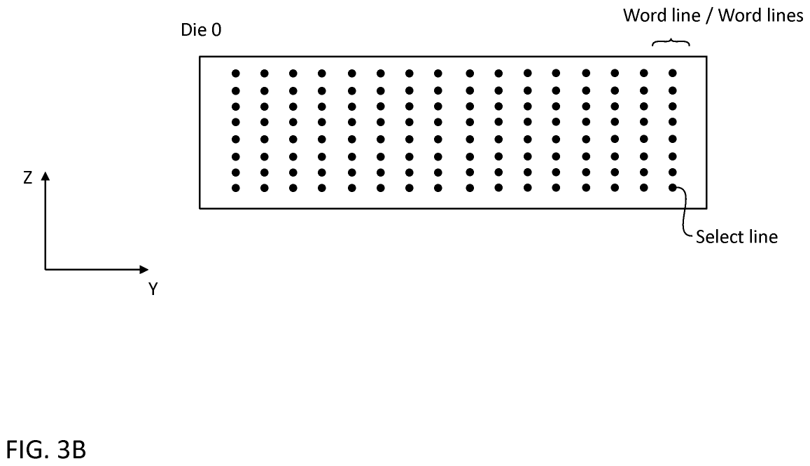

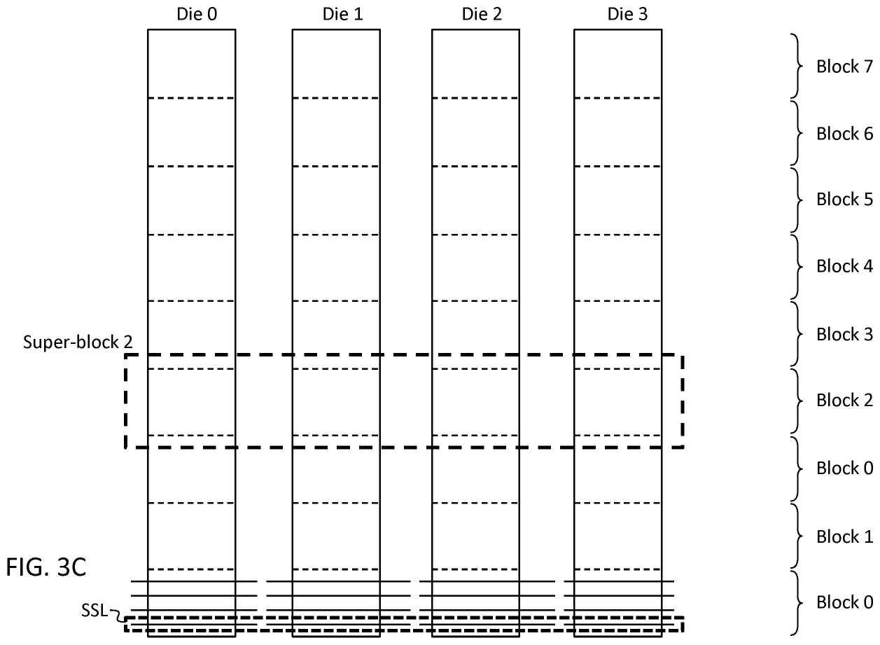

FIG. 3A shows aspects of internal structure of a die 150. Each die may include a plurality of memory cells 305, each being at an intersection of a bit line and a word line, and each including a floating-gate field effect transistor. The floating-gate field effect transistor may include a floating gate, which may be a conductive layer between the channel of the floating-gate field effect transistor and a control gate of the floating-gate field effect transistor. The floating gate may not be connected by conductors to any other conductors of the floating-gate field effect transistor, but it may be capable of storing charge and of exerting an electric field on the channel of the floating-gate field effect transistor, the electric field being one that depends on the charge stored on the floating gate. The charge on the floating gate may be altered, when the memory cell is erased or programmed by tunneling currents.

Each memory cell may be configured to operate as a single-level cell (SLC), multi-level cell (MLC), three-level cell (TLC) or quad level cell (QLC) (or as a cell with a larger number of “levels”). The number of levels, in this terminology, corresponds to the number of bits that may be stored in the cell; for example, a three level cell may be configured to be programmed to be in any one of eight states (corresponding to eight different amounts of charge on the floating gate) and a quad level cell may be configured to be programmed to be in any one of sixteen states (corresponding to sixteen different amounts of charge on the floating gate).

In an array of single-level cells, multi-level cells, or three-level cells, each memory cell may be addressable by a combination of a bit line (the bit lines being shown as conductors parallel to the Y axis in FIG. 3A) and a word line (the word lines being shown as conductors parallel to the X axis in FIG. 3A). Each die may be a substantially planar structure, fabricated on the upper surface of a semiconductor chip (e.g., on the upper surface of a crystalline silicon chip). The surface of this planar structure may be parallel to the X-Y plane of the illustration of FIG. 3A.

The semiconductor chip may include a single layer of memory cells, or (in an embodiment that may be referred to as a “multilayer die”), the semiconductor chip may include a plurality of layers stacked one above the other as illustrated in the cross-sectional view, taken along a cutting plane parallel to the Y-Z plane, shown in FIG. 3B. In the terminology used for quad level cells, each word line includes a plurality of select lines, stacked vertically (e.g., stacked in a direction parallel to the Z axis, as illustrated in FIG. 3B). In the terminology used for single-level cells, multi-level cells, or three-level cells, the stacked conductors that extend parallel to the X direction may be referred to as word lines. As used herein, the term “select line” is synonymous with the term “word line” in the context of single-level cells, multi-level cells, or three-level cells. Some dies may include a mixture of different kinds of cells, e.g., a die may include (i) a plurality of three-level cells and (ii) a plurality of quad-level cells.

Capacitive coupling between the select lines may cause programming of a first memory cell, performed using a first select line, to disturb the charge stored on the floating gate of a second memory cell using another select line within the same word line. This may result in an erroneous value being read from the second memory cell during a subsequent read operation. This behavior may be more important for memory cells storing more (e.g., four) bits per cell, within which the charge states corresponding to different stored values may be more closely spaced.

The disturbing of the charge stored on the floating gate of a second memory cell when a first memory cell, sharing a word line with the second memory cell, is programmed may be mitigated by performing two-pass programming. In two-pass programming, each cell of a word line is first programmed using a first pass, and, once the first programming pass has been completed for each cell of the word line, each cell is programmed again, using a second programming pass. The second programming pass of each cell may be used to correct for any change in the charge on the floating gate caused by the programming of other cells in the same word line. As such, the second programming pass may cause a relatively small change in the floating gate of the floating-gate field effect transistor being programmed, and, accordingly, the second pass may cause a relatively (and acceptably) small disturbance to the charge of other floating-gate field effect transistors on the same word line. A memory cells that is a single-level cell (SLC), multi-level cell (MLC), or three-level cell (TLC) may be programmed using one-pass programming (e.g., using only one programming pass). A memory cell that is a quad level cell (QLC) may be programmed using two-pass programming.

For example, the programming of sixteen memory cells connected to sixteen respective select lines of two word lines, numbered 0 and 1, may proceed as follows, for cells, and the corresponding select lines, numbered 0 through 15. First the system may perform eight first-pass programming operations, on select lines 0 through 7 (which may be part of word line 0), then the system may perform eight pairs of first-pass and second-pass operations, e.g., the first pair including a first-pass operation on select line 8, followed by a second-pass operation on select line 0, the second pair including a first-pass operation on select line 9, followed by a second-pass operation on select line 1, and so on, with each pair including a first-pass operation on select line N and a second-pass operation on select line N−8, with N being the positive integers ranging from 8 to 15. The system may then perform eight second-pass operations, on select lines 8 through 15. Once a select line has been used for a (one-pass or two-pass) programming operation (or “write operation”), it may not be written again until after the block has been erased and recycled into a pool of available blocks maintained by the storage device 110.

The NAND-flash dies 150 of the nonvolatile storage 130 of the storage device 110 may be divided into blocks as shown in FIG. 3A and in FIG. 3C (of which eight are shown per die, in FIG. 3C, for ease of illustration; in some embodiments each NAND-flash die 150 includes more than eight blocks). As shown in FIG. 3C, the blocks may be grouped across the dies, each group being referred to as a super-block with, e.g., super-block 2 (shown inside a dashed rectangle) including block 2 of each of the NAND-flash dies 150. As mentioned above, each block may include a plurality of select lines (SLs) (of which four are shown for ease of illustration; in some embodiments each block includes more than four select lines). The select lines may be grouped together across blocks into groups of select lines referred to as “super select lines” (SSLs), with, for example, super select line 0 including select line 0 of each block in super-block 0.

In operation, when data is being written to the storage device 110, data may arrive from the host 105 at different rates in the different streams. As a result, die contention (contention, by the streams for the NAND-flash dies 150) may occur. For example, a first stream may be in the process of writing select line 0 for each block of super-block 0 and a second stream may be in the process of writing select line 0 for each block of super-block 2. Each stream may be writing one die at a time, advancing to the next die each time a write is completed for one die. If the first stream is behind the second stream (i.e., less advanced along the sequence of dies than the second stream), and if data is arriving more quickly in the first stream, then the first stream may catch up to the second stream (e.g., the first stream may be prepared to write a certain die while the die is still being used by the second stream). This situation, in which one stream is prevented from writing to a certain die because the die is being used by (is in the process of completing a write operation for) another stream may be referred to as write contention. If write contention is not mitigated, then it may result in degraded performance, e.g., the first stream in the example above, may be idle, and one or more other dies may be idle, while the first stream waits for the second stream. In addition to streams carrying data from the host 105, one or more streams carrying data being relocated for garbage collection, and one or more streams for erasing blocks (once garbage collection has cleared them of user data) may also use the NAND-flash dies 150.

As such, in some embodiments, a system for tracking the availability of select lines and dies may be used to allow a first stream, which otherwise might wait for a second stream, to perform a different write operation, when one or more write operations to be performed by the first stream is temporarily prevented as a result of one or more dies being busy. Such a system may be referred to as a “system for die selection”.

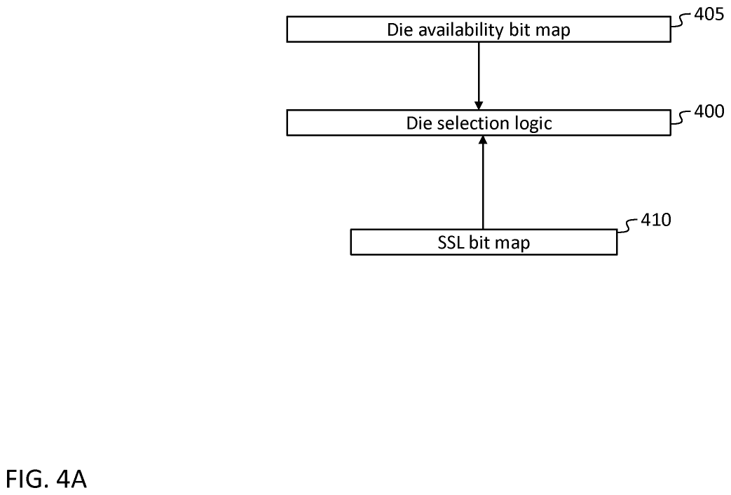

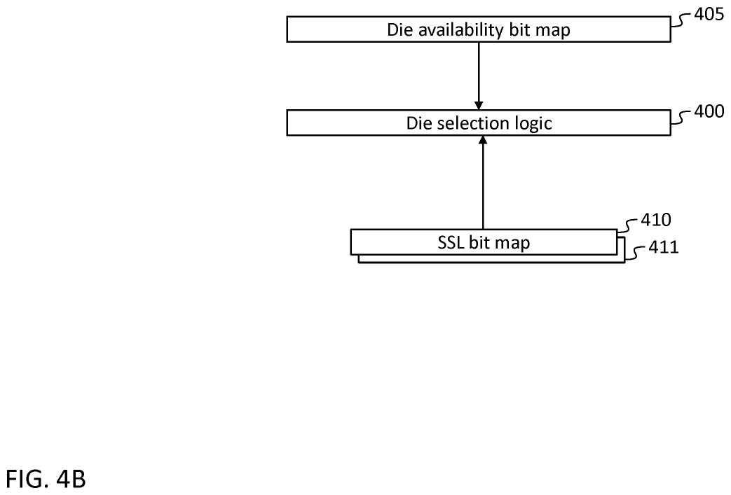

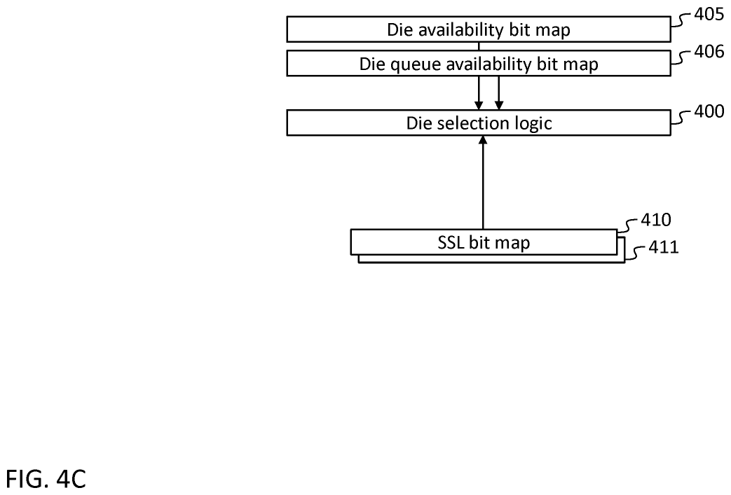

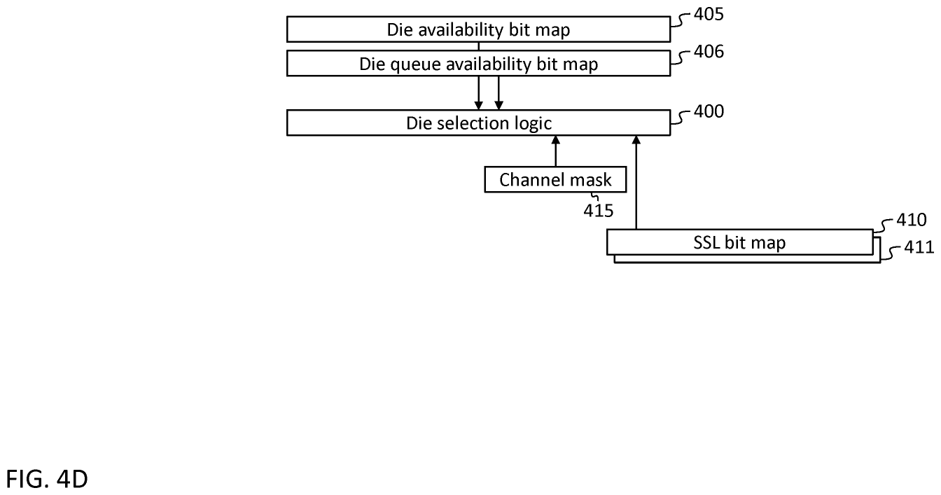

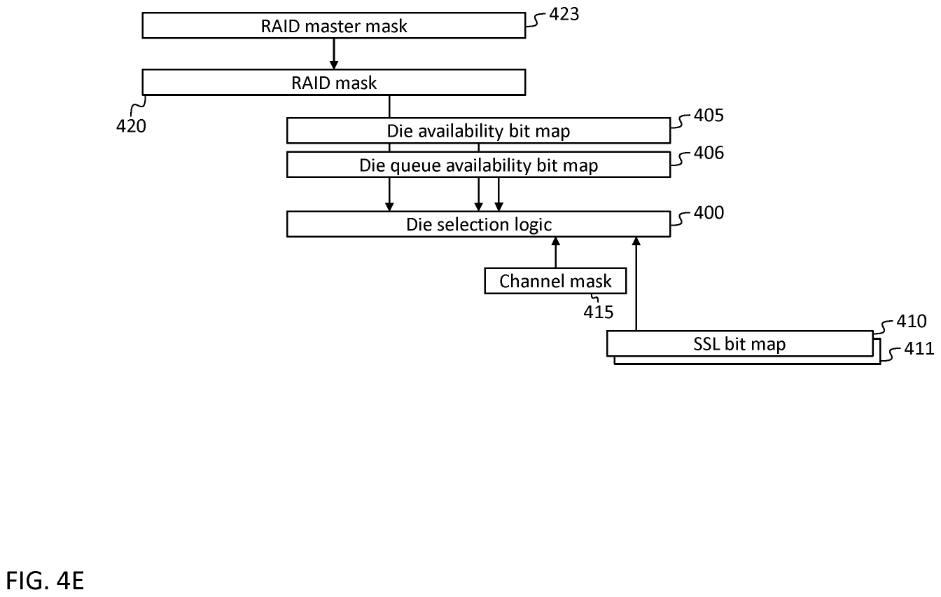

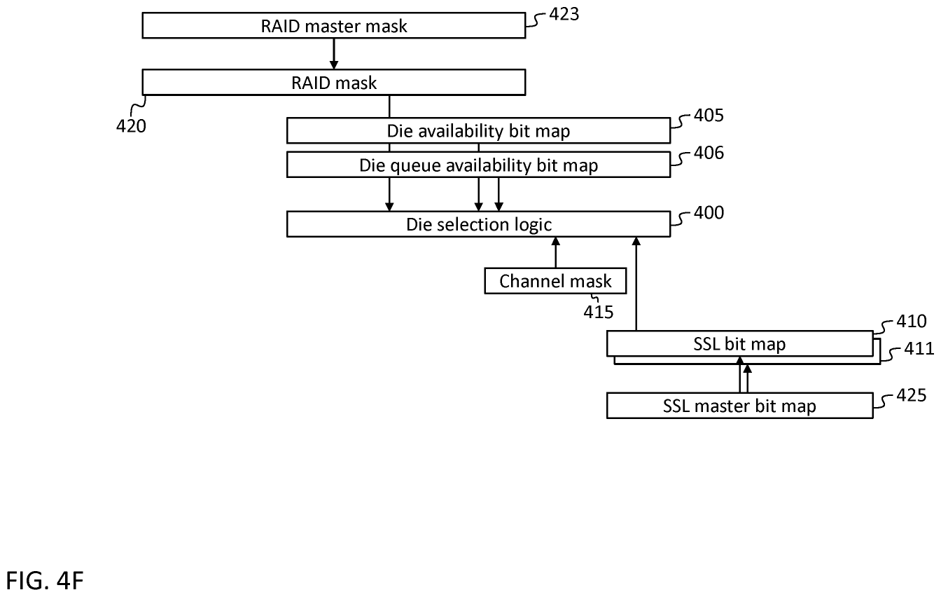

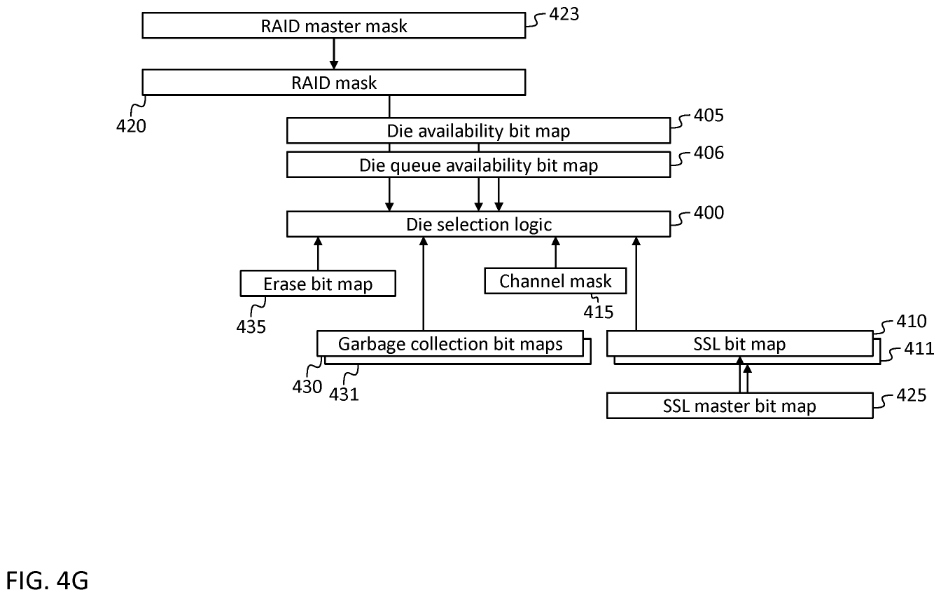

FIG. 4A shows a system for die selection, in some embodiments. A die selection logic circuit 400 (which may be implemented in firmware or in hardware in the storage device controller 125) processes requests in order, from one stream at a time, the stream to be served next being selected, for example, by a stream arbiter. The system for die selection includes (i) a die availability bit map 405 including one bit for each die in the nonvolatile storage 130 and (ii) a first super select line bit map 410, which may be a bit map containing a bit for each die, for the current super select line. The first super select line bit map 410 may be stored in a storage space which may be referred to as a bit map storage space.

Each bit of the die availability bit map may indicate whether the corresponding die is available for a write operation, e.g., the bit may be set if the die is available and the bit may be cleared if the die is not available (e.g., if the die is occupied performing another write command). Each bit of the super select line bit map may correspond to a respective die of the nonvolatile storage 130 and may indicate whether the select line of the die, within the current super select line (the super select line currently being written to by the selected stream) is available for writing (e.g., has not yet been written to). To select a die to be written to next by the stream, the system for die selection may find a die for which both the corresponding bit of the die availability bit map and the corresponding bit of the super select line bit map are one. For example, the system for die selection may perform an AND operation with the two bit maps, and select a die from the set of dies for the which the result of the AND operation is one.

This approach may ensure that for a stream currently writing an Nth super select line, a write operation is only performed using a certain select line (within the super select line) if (i) the select line has not already been written to and (ii) the die containing the select line is available for a write operation (e.g., the die is not currently performing a write operation for another stream).

Once a die has been allocated to the stream, the stream may dispatch a write operation to the die, and the system for die selection may then proceed to similarly select a die for the next stream selected by the stream arbiter. The system for die selection may maintain a separate super select line bit map for each stream.

For both bitmaps (the super select line bit map and the die availability bit map), one of the values of zero or one is selected to indicate availability, the other is selected to indicate unavailability. The system may AND the values for the die and the super select line. to find pairs with a value that indicates availability. As used herein, “set” may mean zero or one, and “cleared” may mean zero or one, and the value corresponding to a bit that is set may be different from the value corresponding to a bit that is cleared. The value of a set bit may be assumed herein to be one, but this disclosure is not limited to such embodiments and in some embodiments a set bit instead has a value of zero. In some embodiments, the system for die selection maintains more than one super select line bit map for each stream, as illustrated in FIG. 4B. in the embodiment of FIG. 4B, the system for die selection maintains two super select line bit maps for each stream, a first super select line bit map 410 for the current super select line being written by the stream (e.g., super select line N) and a second super select line bit map 411 for the next super select line being written by the stream (e.g., super select line N+1). Each bit of the second super select line bit map 411 may correspond to a respective die of the nonvolatile storage 130 and may indicate whether the select line of the die, within the next super select line (super select line N+1) is available for writing. Availability for writing may be determined in a manner discussed in further detail below. The second super select line bit map 411 may be stored in a second storage space which may also be referred to as a bit map storage space. In some embodiments, only a single super select line bit map 410 is present, and in some embodiments, more than two super select line bit maps are present. In some embodiments in which both one-pass memory cells and two-pass memory cells are present in the storage device 110, two super select line bit maps are used except when a stream is crossing a boundary between a region with one-pass memory cells and a region with two-pass memory cells. During such a crossing the system may temporarily use only one super select line bit map.

In such an embodiment, to select a die to be written to next by the stream, the system for die selection may find a die for which both the corresponding bit of the die availability bit map and (i) the corresponding bit of the current super select line bit map (e.g., super select line N) or (ii) the corresponding bit of the next super select line bit map (e.g., super select line N+1) are one. For example, the system for die selection may perform (i) a first AND operation with the die availability bit map and the first super select line bit map 410, and (ii) a second AND operation with the die availability bit map and the second super select line bit map 411. Any die for which the result of the first AND operation or the result of the second AND operation indicates availability is a candidate for the next write operation to be performed by the stream. As such, the system for die selection may select one such die and dispatch the next write operation for the stream to the selected die.

If more than one bit is set in the two bit maps, the system for die selection may choose from (i) the dies for which the first AND operation returned a one and (ii) the dies for which the second AND operation returned a one, according to a priority ranking (discussed in further detail below). For example, the system for die selection may select from among the ones returned by the second AND operation only if the first AND operation returned no ones.

In some embodiments, each die may be associated with a respective queue and the system for die selection may maintain a die queue availability bit map 406, in addition to the die availability bit map 405, as shown in FIG. 4C. The die queue may be used to store one or more write operations to be performed on the die after a current write operation has been completed, and the die queue availability bit map 406 may include one bit for each die of the nonvolatile storage 130, the bit being set if the die queue has space to store a write operation. If the die queue is full, then the corresponding bit of the die queue availability bit map 406 may be cleared. In such an embodiment, the system for die selection may dispatch a write command to either (i) a die for which the bit in the die availability bit map 405 is set, or to (ii) a die queue for which the bit in the die queue availability bit map 406 is set, in accordance with the priority ranking.

In some embodiments, the system for die selection may select dies in an order that improves the throughput in a subsequent read operation. For improved throughput during read operations, the data to be read may be distributed over all of the channels of the nonvolatile storage 130, so that the full total throughput of the channels may be achieved during a read operation. To distribute the data being written by a stream over all of the channels, the system for die selection may use, as shown in FIG. 4D, a channel masking bit map (or “channel mask”) 415 which includes one bit per die. The channel masking bit map 415 may be initialized so that all of the bits are set. Each time a die is allocated to a write operation, the bit for the allocated die, and the bits for all of the other dies in the same channel, may be cleared. The channel masking bit map may be combined, in an AND operation, with one or more of (i) the die availability bit map 405 or the die queue availability bit map 406, and (ii) the first super select line bit map 410, or the second super select line bit map 411, and the ones in the result of the AND operation (assuming a logical one is used to indicate availability; a different logical operation may used, instead of AND, if either or both of the bit maps use the convention that zero indicates availability) may be used as candidates for the write operation, from which one die may be selected using the priority ranking (discussed in further detail below). In this manner, it may be the case that no write operation is sent to a channel in which a write operation has been performed until a write operation has been performed in each of the other channels.

In some embodiments, such as that illustrated in FIG. 4E, one or more redundant arrays of independent dies (RAIDs) may be implemented in the nonvolatile storage 130. For example, eight dies, e.g., dies 0 through 7, may form such an array, with dies 0 through 6 storing data and die 7 storing parity data. The data may be fed to the storage device controller 125 by the stream in increments, so that it may not be possible to calculate the parity data until all of the data has been stored. As such, a masking bit map for the redundant array of independent dies (or “RAID mask”) 420 may include one bit for each of the eight dies. The masking bit map for the redundant array of independent dies 420 may be initialized from a master mask for the redundant array of independent dies 423, which may include the pattern (e.g., seven ones and one zero) to be stored in the masking bit map for the redundant array of independent dies 420 when the masking bit map for the redundant array of independent dies 420 is initialized.

The seven bits, of these eight bits, that correspond to dies that are to be used to store data (e.g., dies 0 through 6) may initially be set, and the bit that corresponds to the die that will store parity data may initially be set to zero. The masking bit map may be included in the AND operation that identifies candidate dies, and, as such, only dies for which the bit of the masking bit map for the redundant array of independent dies 420 is set are written. Once a die has been written, the corresponding bit is cleared. Once all of the dies that are to be used to store data (e.g., dies 0 through 6) have been written, the write operation for the parity data (which may be written, for example, to die 7) is performed, and the masking bit map for the redundant array of independent dies 420 is again initialized to be set for each die that is to be used to store data (e.g., dies 0 through 6) and to be cleared for the die (e.g., die 7) that is to be used to store parity data.

The write operation for the parity data may be performed by checking whether the die to which the parity data is to be written, or its queue, is available, and, (i) if so, writing the parity data or storing the write operation in the die queue, and (ii) if not, storing the write operation in a deferred queue for the die. The system for die selection may maintain a deferred queue, in addition to the die queue, for each die. The deferred queue for the die may be checked each time the die becomes available, and write operations stored in the deferred queue may have priority over all other die operations waiting for the die (for example, when the die becomes available for writing, the write operation at the head of the deferred queue for the die may be performed, if there are any write operations in the deferred queue).

In some embodiments, the last write operation of data (before the writing of the parity data) is also performed using the deferred queue of the die to which this data is to be written. Such an approach may result in this write being completed earlier (because of the high priority accorded to write operations stored in the deferred queue) than if it is performed by an ordinary write operation on the next occasion on which the die is available when the stream is processed.

Some embodiments may support the operation of a domain in the storage device 110. When a domain is defined, the system for die selection may allocate only dies from within the domain for write operations (other, separate systems for die selection may allocate other dies, in other domains). To support operation with a domain, a super select line master bit map 425, having a bit that is set in each bit position corresponding to a die that is in the domain, may be used, as illustrated in FIG. 4F, to initialize the super select line bit maps 410, 411 or to determine (as discussed in further detail below) whether a bit in the second super select line bit map 411 is eligible for setting. The super select line master bit map 425 may include a bit that is set for every die that is part of the domain, and a bit that it cleared for every other die in the nonvolatile storage 130.

As mentioned above, one or more of the streams supplying data to be written to the nonvolatile storage 130 may, as illustrated in FIG. 4G, be garbage collection streams, supplying data which is data being removed from blocks that are being cleared in preparation for erasure. For each garbage collection stream a first garbage collection super select line bit map 430 (for the current super select line) and a second garbage collection super select line bit map 431 (for the next super select line) may be present; these may operate in a manner analogous to that of the first super select line bit map 410 and the second super select line bit map 411.

As mentioned above, one or more of the streams may be an erasure stream, which may include block erase operations instead of write operations. A block erase operation may erase an entire block in a single operation, e.g., performing an erase operation on each word line in the block. As such, the stream may have an erase bit map 435, corresponding to a super-block (instead of corresponding to a super word line, like the first super select line bit map 410), with one bit per die. When an available die is identified, for the erasure stream, by the system for die selection, the erasure stream may erase the block currently identified for erasure within the available die.

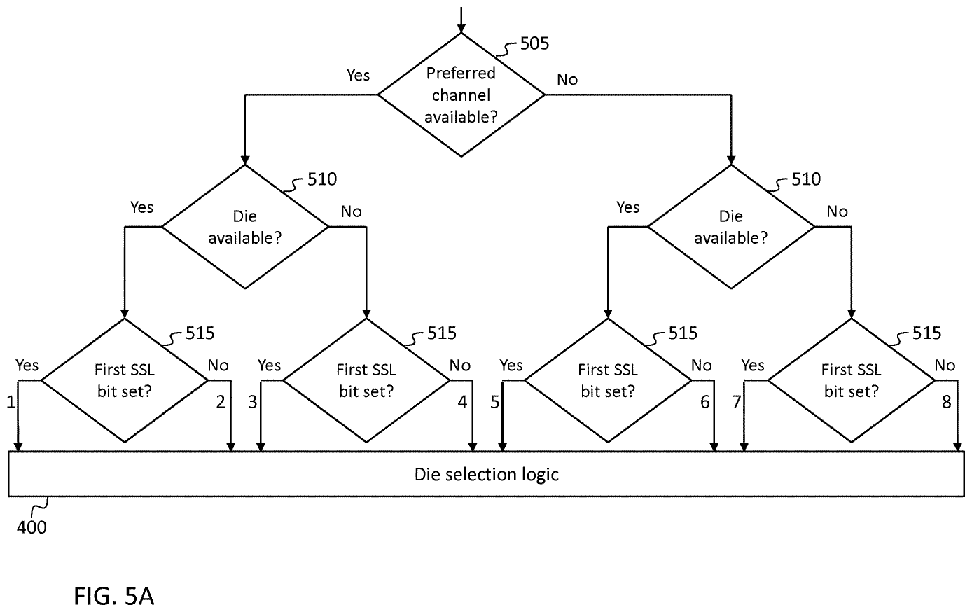

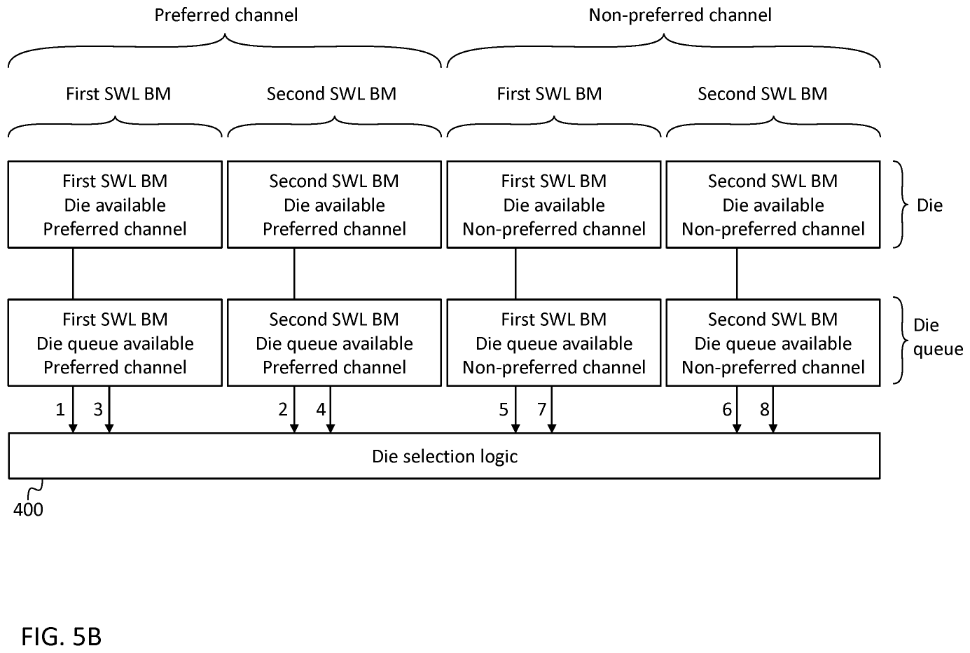

As mentioned above, an AND operation of two or more bit maps may be performed to determine which dies are candidates for a write operation. The AND operation may include (i) a bit map selected from the die availability bit map 405 and the die queue availability bit map 406, and (ii) a bit map selected from the first super select line bit map 410 and the second super select line bit map 411. Further, the AND operation may or may not include the channel masking bit map 415. The eight results that these respective eight combinations may produce are shown in FIGS. 5A and 5B, based on one possible priority ranking. The priority ranking shown in FIGS. 5A and 5B is one in which the bit being set in the channel masking bit map 415 is treated as more important than (e.g., weighted more heavily than) the availability of a die (as opposed to a die queue), and the availability of a die (as opposed to a die queue) is treated as more important than a bit being set in the first super select line bit map 410 (as opposed to a bit being set in the second super select line bit map 411). Other weightings for the three bit map types (the channel masking bit map 415, the die availability bit map, and the super select line bit map) may result in a different priority ranking from that shown in FIGS. 5A and 5B. The first and eighth positions in the ranking may, however, remain unchanged.

FIG. 5A shows a decision tree that may be used to select a die when more than one of the eight results includes a bit that is set. At 505, it is determined whether any of the preferred channels has a die or die queue available for which a bit is set in either the first super select line bit map 410 or the second super select line bit map 411. If the answer is yes, then the left half of the tree is followed, otherwise the right half of the tree is followed. At 510, it is then determined whether a die is available (as opposed to only a die queue being available) for which a bit is set in either the first super select line bit map 410 or the second super select line bit map 411. If the answer is yes, then left branch is followed, otherwise the right branch is followed. At 515, it is then determined whether a bit is set, for the available die or die queue in the first super select line bit map 410 (as opposed to a bit being set only in the or the second super select line bit map 411). If the answer is yes, then left branch is followed, otherwise the right branch is followed. This results in a priority ranking with the priority levels shown in the digits immediately above the die selection logic circuit 400, each priority level being the priority given to the bit map fed into the die selection logic circuit 400 at the input labeled with the digit shown.

The priority ranking is also shown, in FIG. 5B, by the priority levels shown in the digits immediately above the die selection logic circuit 400, each priority level being the priority given to the bit map fed into the die selection logic circuit 400 at the input labeled with the digit shown. In some embodiments these combinations are tested in an order specified by the priority ranking.

For example, the first priority (labeled with the digit “1”) is assigned to the AND operation that results in bits that are set when all three of the following conditions are true: (i) the bit for the die is set in the first super select line bit map 410, (ii) the bit for the die is set in the die availability bit map 405, and (iii) the bit for the die is set in the channel masking bit map 415. In some embodiments, the system for die selection evaluates the AND combinations in order of priority until it finds one that includes a set bit. For example, the system for die selection may evaluate the first priority AND combination first and (i) if a bit is set in this combination, dispatch the corresponding write operation and (ii) if no bit is set in this combination, proceed to the next combination (e.g., to the AND combination with priority 2).

The last (eighth) priority is assigned to the AND operation that results in bits that are set when all three of the following conditions are true: (i) the bit for the die is set only in the second super select line bit map 411 (and not in the first super select line bit map 410), (ii) the bit for the die is set in the die queue availability bit map 406 (and not in the die availability bit map 405), and (iii) the bit for the die is not set in the channel masking bit map 415. The priority ranking may be arbitrary, and need not be one that is capable of being represented by a decision tree (like the decision tree of FIG. 5A).

If only one super select line bit map is used, then it may be initialized with all of the bits set (i) when a stream first begins to send data to the storage device 110 and (ii) whenever all of dies have been written for the super select line for which bits are stored in the super select line bit map. If two (or more) super select line bit maps are used, then each bit of the second super select line bit map 411 may be set only when the corresponding die has been written in the current select line.

If the memory cells are ones that use a two-pass write operation, then a next select line (e.g., select line N+1) of a die may not be available for writing until the second-pass write operation has been dispatched for (e.g., a die has been assigned to the second-pass write operation for) the select line that is the second-pass select line associated with the current select line (associated with select line N). After a first-pass write operation has been performed using a select line (e.g., select line K, which may be the current select line or the next select line), the system may perform a second-pass write operation on the select line that is the second-pass select line associated with select line K (e.g., it may perform a write operation on select line K-8). This may be accomplished by dispatching the second-pass write operation to the die if the die or the die queue is available, or by storing the second-pass write operation in the deferred queue for the die.

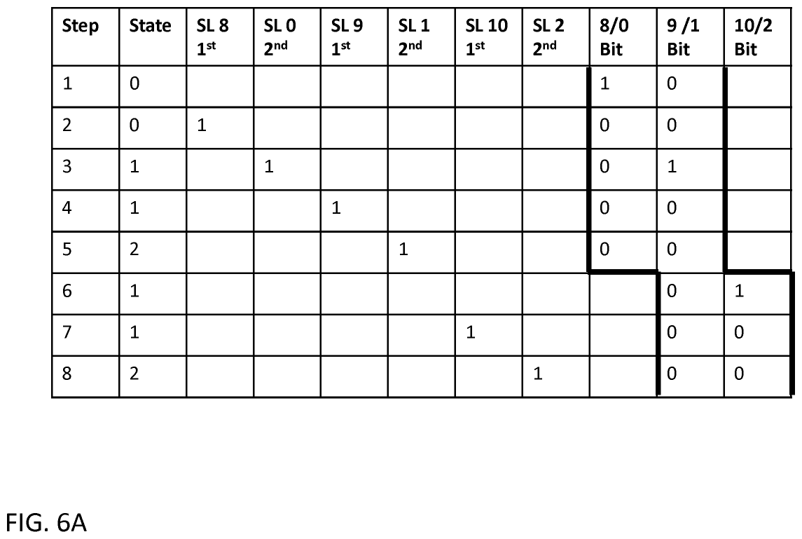

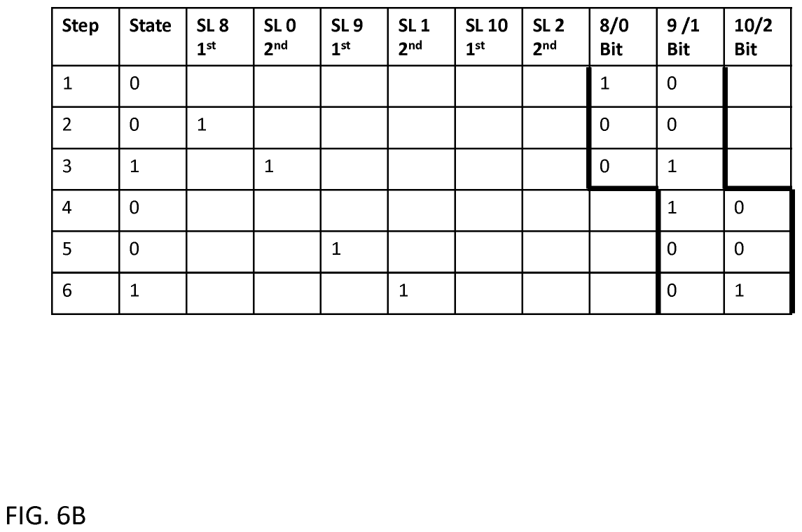

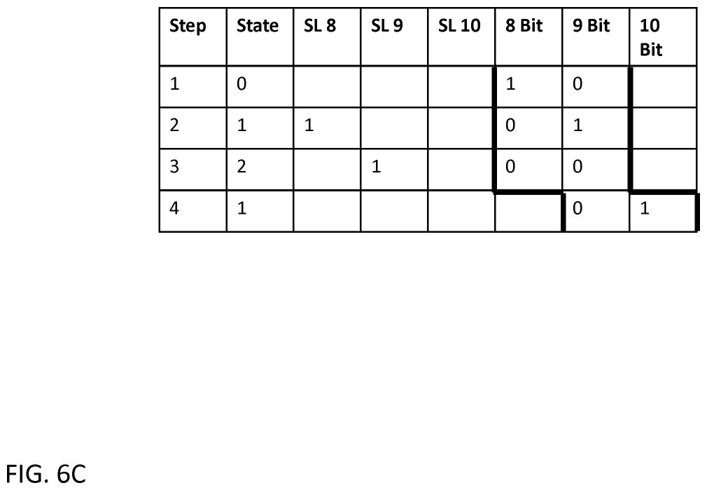

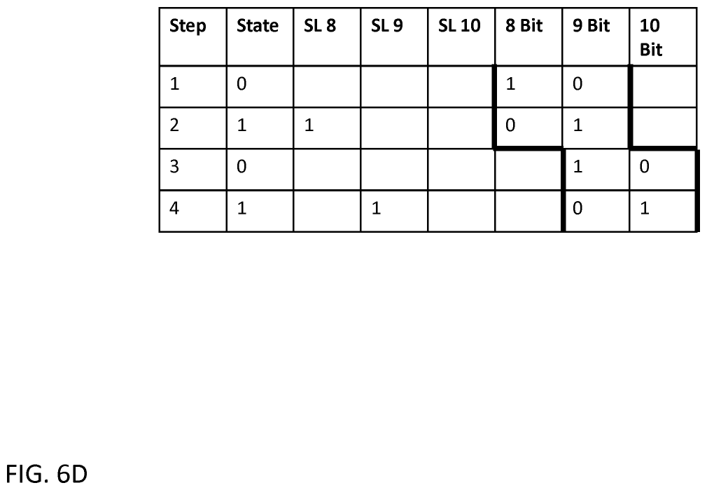

These constraints may be enforced using a state tracker and a bit-setting process as illustrated in FIGS. 6A, 6B, 6C and 6D. The system for die selection may maintain a state tracker (which may be implemented in hardware, firmware, or software) for each die and for each stream (e.g., if the nonvolatile storage 130 includes K dies, then the system for die selection may maintain K state trackers for each stream). FIG. 6A shows a series of write operations for one die, for two-pass memory cells. The first column of FIG. 6A shows a step number, which is used in FIG. 6A to identify changes in the state of the system. The second column of FIG. 6A shows the state of the state tracker, which in the example of FIG. 6A is a counter that is capable of being in three states, numbered 0, 1 and 2. In other embodiments the state tracker may be any other suitable state machine, implemented in hardware, software, or firmware.

The next six columns of FIG. 6A show (by the presence of a “1” in the table) the steps at which first-pass (“1^{st}”) and second-pass (“2^{nd}”) write operations are performed for select lines 8, 9, and 10 (for first-pass write operations) and for the second-pass select lines associated with select lines 8, 9, and 10, which are select lines 0, 1, and 2, respectively. The last three columns of FIG. 6A show the value of the bit, corresponding to the die, in the first super select line bit map 410 and the second super select line bit map 411. Values between the heavy lines of FIG. 6A show the bits that are stored in the bit map storage spaces.

At step 1, the current select line is select line 8 and the second-pass select line associated with the current select line is select line 0. The bit in the select line bit map for the current select line is 1, which means that this select line is available for writing. As such, in step 2, a first-pass write operation is performed using select line 8, and the bit in the select line bit map for the current select line (select line 8) is cleared. In the next step (step 3) the state tracker is incremented to state 1. The state tracker is incremented by one whenever the die is assigned to a second-pass write operation, and decremented by one whenever the bit map storage space storing the first super select line bit map 410 becomes available (no longer being needed to track the current super select line) and is allocated (e.g., reallocated) to select line N+2.

The state of the state tracker may be used to determine (i) when to reallocate the bit map storage space and (ii) what value to set for the bit, corresponding to the die, in the bit map storage space immediately after it is reallocated. For example, reallocation of the bit map storage area may be performed when (i) all of the bits of the first super select line bit map 410 are cleared and (ii) each state tracker is not in state 0 (e.g., each state tracker is in either state 1 or state 2). When the bit map storage area is reallocated (and the state tracker is decremented), the bit of the second super select line bit map 411 may be set to the value of the state tracker, after the state tracker has been decremented.

At step 3 in FIG. 6A, a second-pass write operation is performed using select line 0, and, accordingly, the state of the state tracker is incremented to 1 (incremented from a value of 0 at step 2 to a value of 1 at step 3) and the bit of the second super select line bit map 411 is set (the next select line having become available for writing as a result of the performing of the second-pass write operation in select line 0). At this point, the current select line of the present die no longer needs the first super select line bit map 410. The bit map storage space may however, for reasons of efficiency, be reallocated at the same time for all dies; in the example of FIG. 6A, at least one of the other dies has not completed the second-pass write operation of select line 0, and, as such, the bit map storage space is not reallocated at the end of step 3. Instead, the die continues, using the second super select line bit map 411, which stores a 1, meaning that select line 9 is available for a first-pass write operation; this operation is performed at step 4, and, at step 5, the second-pass write operation is performed in the second-pass select line associated with select line 9 (i.e., in select line 1). The performing of the second-pass write operation causes the state tracker state to be incremented, to a value of 2.

The system for die selection then determines that (i) all of the bits of the first super select line bit map 410 are cleared and (ii) the state tracker state is 1 or 2 in each of the dies (a value of 1 or 2 signifying that the die has completed the second-pass write operation using select line 0), and, accordingly, the bit map storage space that was, until the end of step 5, used to store the first super select line bit map 410, is reallocated to select line 10, so that select line 9 becomes the current select line, and select line 10 becomes the next select line. In step 6, the state of the state tracker is decremented (to a value of 1) and the value of the bit in the second super select line bit map 411 is set to this value (i.e., to 1). The system then performs, in step 7, a first-pass write operation using select line 10, and, in step 8, a second-pass write operation using select line 2.

FIG. 6B is a similar table illustrating a similar process in which, however, at the end of step 3, each of the other dies also has a bit in the first super select line bit map 410 that is cleared, and a state tracker state that is not zero (e.g., that is equal to 1 or 2). As a result of this, the bit map storage space storing the first super select line bit map 410 is reallocated at the end of step 3, and the counter is decremented to 0, which results in the bit of the second super select line bit map 411 being set, immediately after the reallocation, to 0. Step 4 shows a state change (the reallocation of the bit map storage space and the decrementing of the state tracker) without a write cycle, and, as such, the next write operation occurs in step 5.

FIG. 6C is a similar table illustrating the corresponding process for one-pass memory cells. In such an embodiment, the state tracker may be incremented whenever a write is performed, and decremented whenever a bit map storage space is allocated to a new super select line bit map. When select line 8 is written, in step 2 (in response to the corresponding bit of the first super select line bit map 410 being set), the corresponding bit of the first super select line bit map 410 is cleared and the bit of the second super select line bit map 411, corresponding to select line 9, is set, which enables select line 9 to be written at step 3. in the example of FIG. 6C, at least one of the other dies has not completed the second-pass write operation of select line 0, and, as such, the bit map storage space is not reallocated at the end of step 2. At the end of step 3, the bit map storage space is reallocated, in response to the state tracker value being nonzero (in all of the dies, in this example), and in response to the bit of the first super select line bit map 410 being cleared (in all of the dies, in this example).

FIG. 6D is a similar table to that of FIG. 6C, illustrating a similar process in which, however, at the end of step 2, each of the other dies also has a bit in the first super select line bit map 410 that is cleared, and a state tracker state that is not zero (e.g., that is equal to 1 or 2). As a result of this, the bit map storage space storing the first super select line bit map 410 is reallocated at the end of step 2, and the counter is decremented to 0, which results in the bit of the second super select line bit map 411 being set, immediately after the reallocation, to 0.

In some embodiments, each die may include a plurality of planes, which may be accessed independently. In such an embodiment, each plane may be managed in the same manner as the dies in embodiments in which the dies are not accessed using one plane at a time. As such, as used herein, a “storage element” is either a die or a plane. For example, if planes are accessed separately, then a storage element availability bit map, containing one bit per plane, and which indicates the availability of planes for write operations, is used. In an embodiment in which planes are not accessed separately, the storage element availability bit map may be the die availability bit map 405 discussed elsewhere herein.

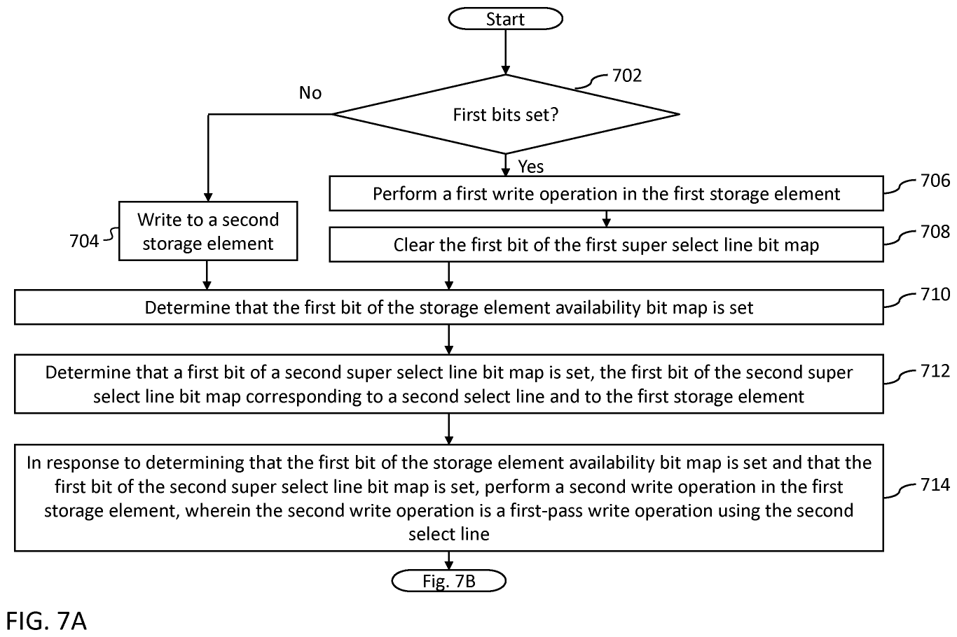

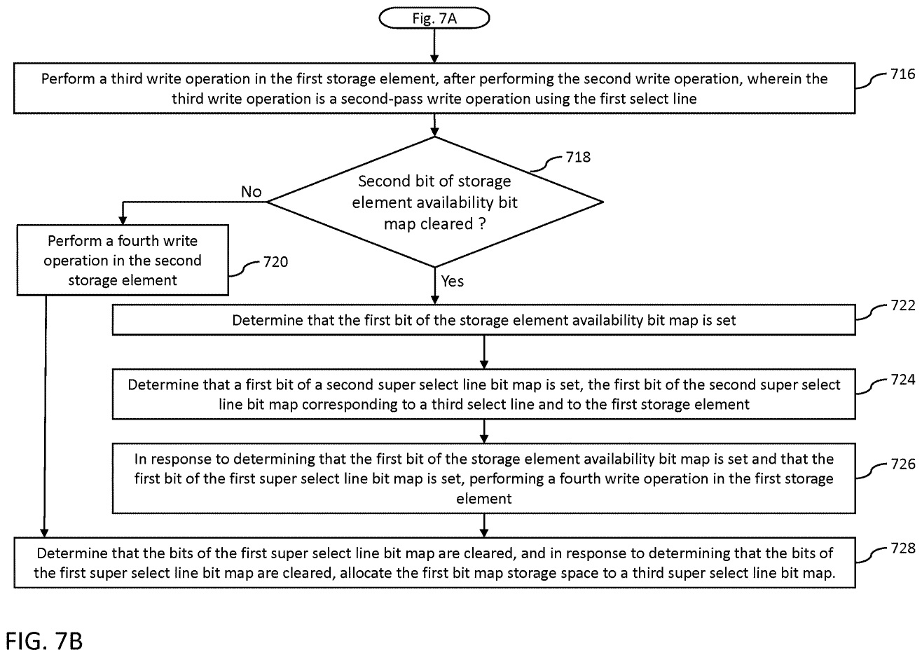

FIGS. 7A and 7B show a method of performing a write operation, in some embodiments. FIGS. 7A and 7B illustrate various operations in such a method, embodiments according to the present disclosure are not limited thereto. For example, according to some embodiments, such a method may include additional operations or fewer operations, or the order of operations may vary (unless otherwise explicitly stated or implied) without departing from the spirit and scope of embodiments according to the present disclosure.

In some embodiments, the method includes determining, at 702, whether a first bit of a storage element availability bit map is set, the first bit corresponding to a first storage element of a nonvolatile memory storage device, the first bit of the storage element availability bit map indicating that the first storage element is available to perform a write operation. For example, as discussed in the context of FIG. 4A, the die availability bit map 405 (an example of a storage element availability bit map) may include a plurality of bits, each indicating whether a corresponding die (an example of a storage element) is available for a write operation. The method further includes determining, at 702, whether a first bit of a first super select line bit map is set, the first bit of the first super select line bit map corresponding to a first select line and to the first storage element. For example, as discussed in the context of FIG. 4A, the first super select line bit map 410 may include a bit for each select line of the current super select line, the bit indicating whether the select line is available for writing (e.g., has not already been written). The method further includes, if, at 702, it is determined that the first bit of the storage element availability bit map is not set or that the first bit of the first super select line bit map is not set, performing a write operation in a second storage element (because the first storage element has been determined not to be available for writing). The method further includes, at 706: if, at 702, it is determined that the first bit of the storage element availability bit map is set and that the first bit of the first super select line bit map is set, performing a first write operation in the first storage element. For example, as discussed in the context of FIG. 4A, to select a die to be written to next by the stream, the system for die selection may find a die for which both the corresponding bit of the die availability bit map and the corresponding bit of the super select line bit map are one. For example, the system for die selection may perform an AND operation with the two bit maps, and select a die from the set of dies for the which the result of the AND operation is one.

In some embodiments, the method further includes clearing, at 708, the first bit of the first super select line bit map (e.g., in response to the select line corresponding to the first bit having been written, which may make the select line ineligible for further write operations). In some embodiments, the first write operation is a first-pass write operation using the first select line. For example, if the memory cells are two-pass memory cells, each cell may be programmed by a first-pass write operation followed by a second-pass write operation.

In some embodiments, the method further includes determining, at 710, that the first bit of the storage element availability bit map is set; determining, at 712, that a first bit of a second super select line bit map is set, the first bit of the second super select line bit map corresponding to a second select line and to the first storage element; and, at 714, in response to determining that the first bit of the storage element availability bit map is set and that the first bit of the second super select line bit map is set, performing a second write operation in the first storage element. In some embodiments, the second write operation is a first-pass write operation using the second select line. In some embodiments, the method further includes performing, at 716, a third write operation in the first storage element, after performing the second write operation, wherein the third write operation is a second-pass write operation using the first select line. For example, as discussed above, in some embodiments, a plurality of first-pass write operations may be performed, using different select lines, before corresponding second-pass write operations are performed using the same select lines.

In some embodiments, the method further includes: determining, at 718, whether a second bit of the storage element availability bit map is cleared, the second bit corresponding to a second storage element of the nonvolatile memory storage device, the second bit of the storage element availability bit map indicating that the second storage element is not available to perform a write operation; and, in response to determining, at 718, that the second bit of the storage element availability bit map is cleared: determining, at 722, that the first bit of the storage element availability bit map is set; determining, at 724, that a first bit of a second super select line bit map is set, the first bit of the second super select line bit map corresponding to a third select line and to the first storage element; and, at 726, in response to determining that the first bit of the storage element availability bit map is set and that the first bit of the first super select line bit map is set, performing a fourth write operation in the first storage element. For example, as discussed above, if a storage element (e.g., the second storage element) is not available for writing, the system for die selection may allocate a different storage element (e.g., the first storage element). The method further comprises, in response to determining, at 718, that the second bit of the storage element availability bit map is not cleared, performing a fourth write operation, in the second storage element. In some embodiments, the first super select line bit map is stored in a first bit map storage space, and the method further includes determining, at 728, that the bits of the first super select line bit map are cleared, and in response to determining that the bits of the first super select line bit map are cleared, allocating the first bit map storage space to a third super select line bit map. In some embodiments, the allocating is further in response to a state of a state tracker, the state tracker being configured to change states in response to: an assignment of a storage element for the performance of a second-pass write operation, or an allocation of a bit map storage space to a super select line bit map. For example, as discussed in the context of FIGS. 6A-6C, if all of the bits of the first super select line bit map 410 are cleared, and if the state of each state tracker is nonzero, then the first bit map storage space may be reallocated.

In some embodiments, the first storage element is a die. In some embodiments, the first storage element is a plane of a die.

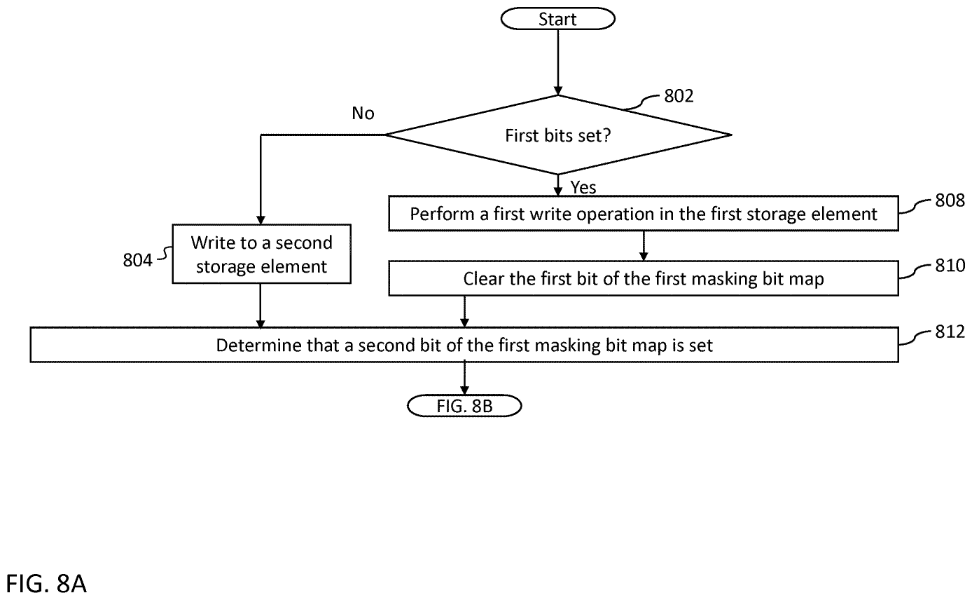

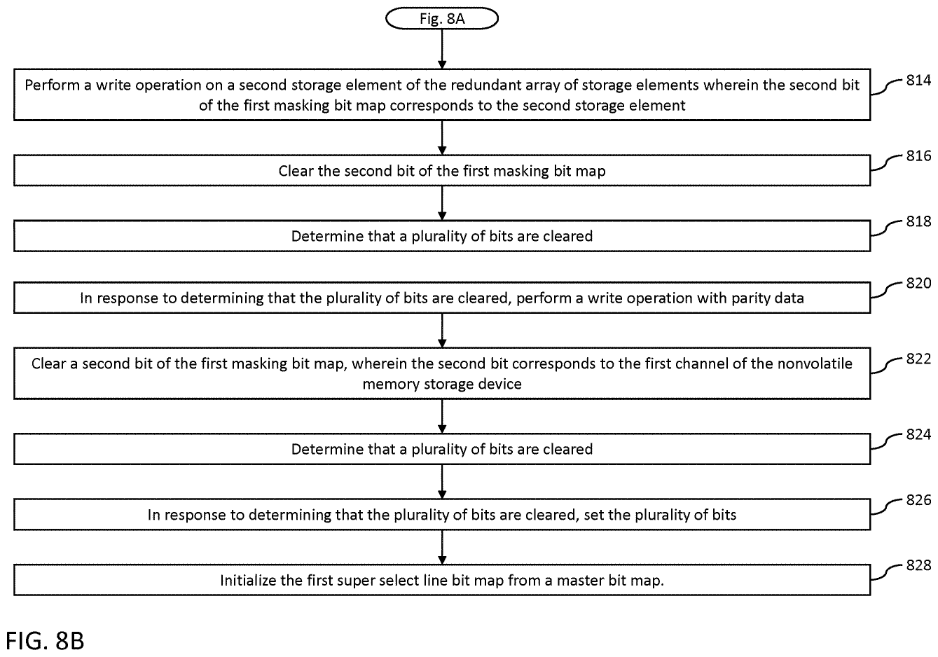

FIGS. 8A and 8B show a method of performing a write operation, in some embodiments. In the method of FIGS. 8A and 8B, masking bit maps are used to (i) ensure that all of the data dies of a RAID are written before the parity data die is written and (ii) to ensure that, once a first write operation has been performed with any channel (e.g., with a first channel), a write operation is performed with each other channel before a second write operation is performed with the first channel. FIGS. 8A and 8B illustrate various operations in such a method, embodiments according to the present disclosure are not limited thereto. For example, according to some embodiments, such a method may include additional operations or fewer operations, or the order of operations may vary (unless otherwise explicitly stated or implied) without departing from the spirit and scope of embodiments according to the present disclosure.

In some embodiments, the method includes: determining, at 802, (i) whether a first bit of a storage element availability bit map is set, the first bit corresponding to a first storage element of a nonvolatile memory storage device, the first bit of the storage element availability bit map indicating that the first storage element is available to perform a write operation; and (ii) whether a first bit of a first super select line bit map is set, the first bit of the first super select line bit map corresponding to a first select line and to the first storage element. As mentioned above, these operations are discussed herein, in the context of FIG. 4A. The method further includes determining, at 802, whether a first bit of a first masking bit map is set, the first bit of the first masking bit map corresponding to the first storage element. For example, as discussed in the context of FIG. 4G, the masking bit map may be a channel masking bit map 415 or a masking bit map for the redundant array of independent dies 420. The method further includes, if, at 802, it is determined that the first bit of the storage element availability bit map is not set or that the first bit of the first super select line bit map is not set, or that the first bit of the first masking bit map is not set, then performing, at 804, a write operation in a second storage element (because the first storage element has been determined not to be available for writing). The method further includes, at 808, in response to determining that the first bit of the storage element availability bit map is set, and that the first bit of the first super select line bit map is set, and that the first bit of the first masking bit map is set, performing a first write operation in the first storage element. For example, as discussed above in the context of FIG. 4G, the masking bit map or masking bit maps may be included in AND operations used to determine which die to allocate for a write operation.

In some embodiments, the method further includes clearing, at 810, the first bit of the first masking bit map. For example, as discussed above in the context of FIG. 4G, once a channel or a die of a redundant array of independent dies has been written, the corresponding bit in the masking bit map may be cleared, so that the die is not written again until the masking bit map is re-initialized. In some embodiments, the redundant array of storage elements includes the first storage element; and the first bit of the first masking bit map corresponds to the first storage element.

In some embodiments, the method further includes: determining, at 812, that a second bit of the first masking bit map is set, and performing, at 814, a write operation on a second storage element of the redundant array of storage elements, wherein the second bit of the first masking bit map corresponds to the second storage element. In some embodiments, the method further includes clearing, at 816, the second bit of the first masking bit map; determining, at 818, that the bits of the plurality of bits are cleared; and, at 820, in response to determining that the bits of the plurality of bits are cleared, performing a write operation with parity data. For example, as discussed in the context of FIG. 4G, once each of the data dies has been written to, and all of the corresponding bits of the masking bit map for the redundant array of independent dies 420 have been cleared, the system may write the parity data. In some embodiments, (e.g., if the first masking bit map is a channel masking bit map 415) the first bit of the first masking bit map corresponds to a first channel of a plurality of channels of the nonvolatile memory storage device. In some embodiments, the method further includes clearing, at 822, a second bit of the first masking bit map, wherein the second bit corresponds to the first channel of the nonvolatile memory storage device.

In some embodiments, the method further includes determining, at 824, that the bits of the plurality of bits are cleared; and, at 826, in response to determining that the bits of the plurality of bits are cleared, setting the bits of the plurality of bits. In some embodiments, the method further includes initializing, at 828, the first super select line bit map from a master bit map (e.g., from the master mask for the redundant array of independent dies 423). In some embodiments, the master bit map includes a plurality of set bits, the set bits corresponding to a domain of the nonvolatile memory storage device.

As used herein, “a portion of” something means “at least some of” the thing, and as such may mean less than all of, or all of, the thing. As such, “a portion of” a thing includes the entire thing as a special case, i.e., the entire thing is an example of a portion of the thing. As used herein, when a second quantity is “within Y” of a first quantity X, it means that the second quantity is at least X-Y and the second quantity is at most X+Y. As used herein, when a second number is “within Y %” of a first number, it means that the second number is at least (1−Y/100) times the first number and the second number is at most (1+Y/100) times the first number. As used herein, the term “or” should be interpreted as “and/or”, such that, for example, “A or B” means any one of “A” or “B” or “A and B”.

Each of the terms “processing circuit” and “means for processing” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

As used herein, when a method (e.g., an adjustment) or a first quantity (e.g., a first variable) is referred to as being “based on” a second quantity (e.g., a second variable) it means that the second quantity is an input to the method or influences the first quantity, e.g., the second quantity may be an input (e.g., the only input, or one of several inputs) to a function that calculates the first quantity, or the first quantity may be equal to the second quantity, or the first quantity may be the same as (e.g., stored at the same location or locations in memory as) the second quantity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed herein could be termed a second element, component, region, layer or section, without departing from the spirit and scope of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that such spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the terms “substantially,” “about,” and similar terms are used as terms of approximation and not as terms of degree, and are intended to account for the inherent deviations in measured or calculated values that would be recognized by those of ordinary skill in the art.

It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the present disclosure”. Also, the term “exemplary” is intended to refer to an example or illustration. As used herein, the terms “use,” “using,” and “used” may be considered synonymous with the terms “utilize,” “utilizing,” and “utilized,” respectively.

It will be understood that when an element or layer is referred to as being “on”, “connected to”, “coupled to”, or “adjacent to” another element or layer, it may be directly on, connected to, coupled to, or adjacent to the other element or layer, or one or more intervening elements or layers may be present. In contrast, when an element or layer is referred to as being “directly on”, “directly connected to”, “directly coupled to”, or “immediately adjacent to” another element or layer, there are no intervening elements or layers present.

Any numerical range recited herein is intended to include all sub-ranges of the same numerical precision subsumed within the recited range. For example, a range of “1.0 to 10.0” or “between 1.0 and 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Similarly, a range described as “within 35% of 10” is intended to include all subranges between (and including) the recited minimum value of 6.5 (i.e., (1-35/100) times 10) and the recited maximum value of 13.5 (i.e., (1+35/100) times 10), that is, having a minimum value equal to or greater than 6.5 and a maximum value equal to or less than 13.5, such as, for example, 7.4 to 10.6. Any maximum numerical limitation recited herein is intended to include all lower numerical limitations subsumed therein and any minimum numerical limitation recited in this specification is intended to include all higher numerical limitations subsumed therein.

It will be understood that when an element is referred to as being “directly connected” or “directly coupled” to another element, there are no intervening elements present. As used herein, “generally connected” means connected by an electrical path that may contain arbitrary intervening elements, including intervening elements the presence of which qualitatively changes the behavior of the circuit. As used herein, “connected” means (i) “directly connected” or (ii) connected with intervening elements, the intervening elements being ones (e.g., low-value resistors or inductors, or short sections of transmission line) that do not qualitatively affect the behavior of the circuit.

Although exemplary embodiments of a storage device have been specifically described and illustrated herein, many modifications and variations will be apparent to those skilled in the art. Accordingly, it is to be understood that a storage device constructed according to principles of this disclosure may be embodied other than as specifically described herein. The invention is also defined in the following claims, and equivalents thereof.

What is claimed is:

1. A method, comprising:
determining that a first bit of a storage element availability bit map is set, the first bit corresponding to a first storage element of a nonvolatile memory storage device, the first bit of the storage element availability bit map indicating that the first storage element is available to perform a write operation;
determining that a first bit of a first super select line bit map is set, the first bit of the first super select line bit map corresponding to a first select line and to the first storage element;
determining that a first bit of a first masking bit map is set, the first bit of the first masking bit map corresponding to the first storage element; and
in response to determining that the first bit of the storage element availability bit map is set, and that the first bit of the first super select line bit map is set, and that the first bit of the first masking bit map is set, performing a first write operation in the first storage element.

2. The method of claim 1, further comprising clearing the first bit of the first masking bit map.

3. The method of claim 2, wherein:
a redundant array of storage elements includes the first storage element; and
the first bit of the first masking bit map corresponds to the first storage element.

4. The method of claim 3, further comprising:
determining that a second bit of the first masking bit map is set, and performing a write operation on a second storage element of the redundant array of storage elements,
wherein the second bit of the first masking bit map corresponds to the second storage element.

5. The method of claim 4, further comprising:
clearing the second bit of the first masking bit map;
determining that a plurality of bits of the first masking bit map are cleared; and
in response to determining that the plurality of bits of the first masking bit map are cleared, performing a write operation with parity data.

6. The method of claim 2, wherein:
the first bit of the first masking bit map corresponds to a first channel of a plurality of channels of the nonvolatile memory storage device.

7. The method of claim 6, further comprising clearing a second bit of the first masking bit map, wherein the second bit corresponds to the first channel of the nonvolatile memory storage device.

8. The method of claim 7, further comprising:
determining that a plurality of bits of the first masking bit map are cleared; and
in response to determining that the plurality of bits of the first masking bit map are cleared, setting the plurality of bits.

9. The method of claim 1, further comprising initializing the first super select line bit map from a master bit map.

10. The method of claim 9, wherein the master bit map comprises a plurality of set bits, the set bits corresponding to a domain of the nonvolatile memory storage device.

11. A nonvolatile storage device, comprising:
a first storage element;
a second storage element; and
a processing circuit, configured to perform a method, the method comprising:
determining that a first bit of a storage element availability bit map is set, the first bit corresponding to the first storage element, the first bit of the storage element availability bit map indicating that the first storage element is available to perform a write operation;
determining that a first bit of a first super select line bit map is set, the first bit of the first super select line bit map corresponding to a first select line and to the first storage element;
determining that a first bit of a first masking bit map is set, the first bit of the first masking bit map corresponding to the first storage element; and
in response to determining that the first bit of the storage element availability bit map is set, and that the first bit of the first super select line bit map is set, and that the first bit of the first masking bit map is set, performing a first write operation in the first storage element.

12. The nonvolatile storage device of claim 11, wherein the method further comprises clearing the first bit of the first masking bit map.

13. The nonvolatile storage device of claim 12, wherein:
a redundant array of storage elements includes the first storage element; and
the first bit of the first masking bit map corresponds to the first storage element.

14. The nonvolatile storage device of claim 13, wherein:
the redundant array of storage elements includes the second storage element; and
the method further comprises:
determining that a second bit of the first masking bit map is set, and performing a write operation on the second storage element,
wherein the second bit of the first masking bit map corresponds to the second storage element.

15. The nonvolatile storage device of claim 14, wherein the method further comprises:
clearing the second bit of the first masking bit map;
determining that a plurality of bits of the first masking bit map are cleared; and
in response to determining that the plurality of bits of the first masking bit map are cleared, performing a write operation with parity data.

16. The nonvolatile storage device of claim 12, wherein:
the first bit of the first masking bit map corresponds to a first channel of a plurality of channels of the nonvolatile memory storage device.

17. The nonvolatile storage device of claim 16, wherein the method further comprises clearing a second bit of the first masking bit map, wherein the second bit corresponds to the first channel of the nonvolatile memory storage device.

18. The nonvolatile storage device of claim 17, wherein the method further comprises:
determining that a plurality of bits of the first masking bit map are cleared; and
in response to determining that the plurality of bits of the first masking bit map are cleared, setting the plurality of bits.

19. The nonvolatile storage device of claim 11, wherein:
the method further comprises initializing the first super select line bit map from a master bit map, and
the master bit map comprises a plurality of set bits, the set bits corresponding to a domain of the nonvolatile memory storage device.

20. A nonvolatile storage device, comprising:
a first storage element;
a second storage element; and
means for processing, configured to perform a method, the method comprising:
determining that a first bit of a storage element availability bit map is set, the first bit corresponding to the first storage element, the first bit of the storage element availability bit map indicating that the first storage element is available to perform a write operation;
determining that a first bit of a first super select line bit map is set, the first bit of the first super select line bit map corresponding to a first select line and to the first storage element;
determining that a first bit of a first masking bit map is set, the first bit of the first masking bit map corresponding to the first storage element; and
in response to determining that the first bit of the storage element availability bit map is set, and that the first bit of the first super select line bit map is set, and that the first bit of the first masking bit map is set, performing a first write operation in the first storage element.
